(19) United States
(12) Patent Application Publication
(10) Pub. No.: US 2024/0428093 A1
(43) Pub. Date: Dec. 26, 2024

(54) 3D/4D AI-INFUSED REASONING AND LOGIC PROGRAMMING PLATFORM

(71) Applicant: Motalen LLC, Troy, NY (US)

(72) Inventors: Selmer Bringsjord, Rensselaer, NY (US); Alexander Bringsjord, Rensselaer, NY (US); Naveen Sundar Govindarajulu, San Jose, CA (US)

(21) Appl. No.: 18/752,122

(22) Filed: Jun. 24, 2024

Related U.S. Application Data
(60) Provisional application No. 63/509,624, filed on Jun. 22, 2023.

(51) Int. Cl. G06N 5/04; G06T 17/00

(52) U.S. Cl. CPC G06N 5/04; G06T 17/00

(57) ABSTRACT

A three-dimensional (3D) logics visualization system. The system includes: an immersive headset configured to visualize a 3D environment; and a system for rendering and processing logic solutions within the 3D environment, the system including: an editor for creating a 3D hypergraph that represents a logic solution to a reasoning problem, wherein the 3D hypergraph includes nodes connected by arcs arranged in an x, y, and z dimension; and an interface manager for viewing the 3D hypergraph from different perspectives.

### PRIORITY CLAIM

This application claims priority to co-pending provisional application 63/509,624, 3D HYPERGRAPHICAL REASONING SYSTEM, filed on Jun. 22, 2023, the contents of which are incorporated by reference.

### TECHNICAL FIELD

The present invention is directed at systems, interfaces, and associated tools for creating and evaluating proofs, arguments, and pure general logic (computer) programs (“logic solutions”) in a three-dimensional (3D) and/or four-dimensional (4D) environment, and for providing and allowing humans to enlist AI automated reasoners in these activities.

### BACKGROUND

Creating and evaluating logic-based reasoning solutions remains an important field as technologies such as artificial intelligence (AI) become more and more advanced. One approach to designing reasoning problems and solutions is to utilize a graphical interface in which proofs and formulas can be visualized, e.g., using nodes and arrows, which allows users to more easily view the logic. However, as reasoning problems become more complex, current visualization platforms cannot adequately represent complicated logic solutions.

### SUMMARY

Aspects of the disclosure provide a three-dimensional hypergraphical system for creating and evaluating “logic solutions” to reasoning problems. The system also allows for representing 3D logic solutions along a fourth dimension, i.e., time.

A first aspect provides a three dimensional (3D) logics visualization system, comprising: an immersive headset configured to visualize a 3D environment; and a system for rendering and processing logic solutions within the 3D environment, the system including: an editor for creating a 3D hypergraph that represents a logic solution to a reasoning problem, wherein the 3D hypergraph includes nodes connected by arcs arranged in an x, y, and z dimension; and an interface manager for viewing the 3D hypergraph from different perspectives.

A second aspect provides a three dimensional (3D) logics visualization system, comprising: a visualization platform configured to visualize a 3D environment; and a system for rendering and processing logic solutions within the 3D environment, the system including: an editor for creating a 3D hypergraph that represents a logic solution to a reasoning problem, wherein the 3D hypergraph includes nodes connected by arcs arranged in 3D space; and an interface manager for viewing the 3D hypergraph from different perspectives; wherein the 3D hypergraph includes nodes and arcs, wherein each node includes one of a formula or a function, and each arc includes an inference.

A third aspect provides a logics visualization system for constructing an n-dimensional (nD) game, comprising: an immersive headset configured to visualize an nD environment; and a system for rendering and processing logic within the nD environment, the system including: an editor for creating a nD hypergraph that represents a series of challenges based on a selected logic, wherein the nD hypergraph includes nodes connected by arcs arranged in the nD environment; an interface manager for viewing the nD hypergraph from different perspectives; and a system for generating a game based on the nD hypergraph, wherein each node comprises a formula that defines an object and a position into nD space, and wherein the selected logic includes gaming rules.

Further aspects include program products for embodying any of the above aspects.

### BRIEF DESCRIPTION OF THE DRAWINGS

These and other features will be more readily understood from the following detailed description of the various aspects taken in conjunction with the accompanying drawings in which:

FIG. 1 shows a logics visualization system according to embodiments.

FIG. 2 shows a generalized example of a 3D/4D visualization interface according to embodiments.

FIG. 3 shows an example anatomy of a node according to embodiments.

FIG. 4 shows a further example of a node according to embodiments.

FIG. 5 shows an illustrative cognitive continuum according to embodiments.

FIG. 6 depicts an inference schema type node according to embodiments.

FIG. 7 depicts two inference schematic nodes used in a proof according to embodiments.

FIG. 8 depicts elements that compose Pure General Logic Programming according to embodiments.

FIG. 9 depicts 2D Pure General Logic Program according to embodiments.

FIG. 10 depicts a 3D proof according to embodiments.

FIG. 11 depicts a visualization interface according to embodiments.

FIG. 12 depicts a 3D hypergraphical proof over time according to embodiments.

FIG. 13 depicts an illustrative 3D visualization according to embodiments.

FIG. 14 depicts a 3D interface according to embodiments.

FIG. 15 depicts a 2D hypergraphical proof of a popular-for-exposition theorem.

FIG. 16 depicts a proof.

FIG. 17 depicts a proof problem.

FIG. 18 depicts a problem being solved with a proof in 2D.

FIG. 19 depicts a proof being translated to 3D according to embodiments.

FIG. 20 depicts an example of a proof with one sub-proof removed from the main view according to embodiments.

FIGS. 21 and 22 depict an example reasoning game referred to as Babel's city according to embodiments.

FIG. 23 depicts an overview of a gaming representation according to embodiments.

FIG. 24 describes a formal cognitive calculus used for inferential cognitive calculus according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Various embodiments provided herein relate to an n-dimensional (e.g., 3D or a 4D) system for creating and processing reasoning-based logic solutions. In one aspect, the system includes an AI-infused platform within which users build proofs, formal arguments, and/or pure logic computer programs, typically as attempts to solve reasoning problems. Formal logic and reasoning (or simply “reasoning”) problems generally comprise any problem or challenge in which the user or other entity is expected to formulate a proof, argument or logic-based solution in which systematic reasoning is employed.

In U.S. Pat. No. 11,526,779, ARTIFICIAL INTELLIGENCE PLATFORM FOR AUTO-GENERATING REASONING PROBLEMS AND ASSESSING SOLUTIONS, issued on Dec. 13, 2022, which is hereby incorporated by reference, discloses a solution editor, referred to as HYPERSLATER that provides a computing environment in which users create logic solutions to reasoning problems in a two-dimensional visual interface. Once the user is satisfied with their solution, they can generate a solution file containing a “hypergraph” and submit the solution file to a solution analyzer. The solution analyzer automatically assesses the solution file and generates a result (success, failure, partial success, grade, etc.).

As noted, as reasoning problems become more complex, logic solutions become more and more complicated and difficult to represent in a simple 2D interface. For example, Cognitive Calculus (CC) is a highly expressive multi-operator model logic in which the cognitive and emotional states of humans can be represented, and automatically reasoned over. CC is described in further detail in U.S. Pat. No. 11,379,732, COUNTER FRAUD SYSTEM, issued on Jun. 5, 2022, which is hereby incorporated by reference. CC can for example be used to model what multiple real actors involved in a scheme believe, know, intend, perceive, etc. Representing highly complex logic solutions to reasoning problems, such as “schemes” to commit fraud, involving multiple humans and human states with a 2D graph is not ideal, as the complexity is beyond what can be represented in 2D.

In order to provide a more robust approach to creating visualizations of solutions to complex reasoning problems, the present solution provides at least a 3D environment for creating hypergraphical logic solutions “hypergraphs.” In certain embodiments, the visualization can also be extended to a fourth dimension of time. In other embodiments, such as gaming, the environment can be extended to n-dimensional environments. The 3D graphical environment can be used for expressing formal arguments, proofs, and pure logic programs (i.e., logic solutions). While logic programs in the narrow sense, such as programs written in the language Prolog, can, when executed, give rise to phenomena that is 3D, the language itself, and the interface between humans and such programs, remains firmly 2D. Likewise, it has been known that ordinary 2D formulae and equations can be used to axiomatize 3D geometries and enable proofs about these geometries—but in these cases, formulae, equations and proofs are not themselves 3D or 4D. Conversely, in the present solution, formulae, equations and proofs are themselves 3D and 4D and viewable in a 3D and 4D visualization platform. The current approach can be used for education or any endeavor in which users are creating systematic arguments or proofs, e.g., intelligence analysts, mathematicians, business, teachers/professors of such material, and so on.

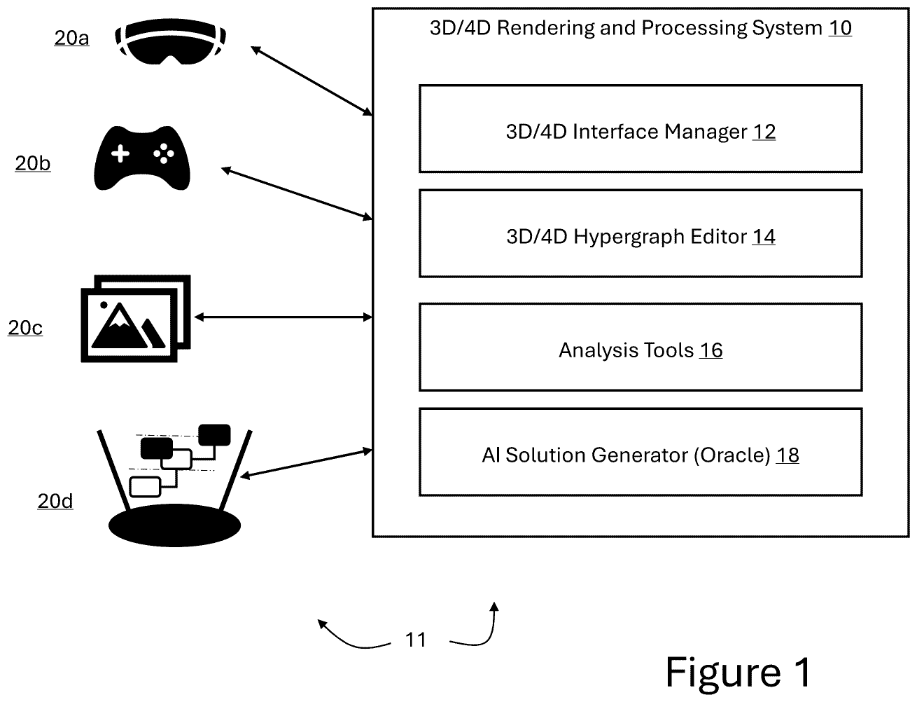

FIG. 1 depicts a logics visualization system 11 that includes a 3D/4D rendering and processing system 10 configured to run on or with various hardware visualization platforms 20a-d. System 10 may be integrated as part of a visualization platform 20a-d, run remotely from a visualization platform 20a-d, or be partially integrated and partially remote. System 10 may be implemented in hardware, software, firmware, or any combination thereof. System 10 generally includes: (1) a 3D/4D interface manager 12 that allows logic solutions, i.e., hypergraphs, to be viewed and manipulated in a 3D/4D spatial-temporal environment; (2) a 3D/4D hypergraph editor 14 that provides editing tools and the like for creating and editing logic solutions; (3) analysis tools 16 configured to analyze logic solutions; and (4) an AI solution generator 18 (also referred to herein as an oracle) that can autogenerate solutions or partial solutions to reasoning problems, as well as implement automated reasoning.

Any now known or later type of hardware visualization platform 20a-d capable of displaying and processing 3D images could be used. In recent years, immersive headsets 20a that sit on a user's head and over a user's eye(s), e.g., including virtual reality (VR) systems such as Apple Vision Pro, augmented reality (AR) systems such as Google Glasses, mixed reality (MR), etc.) have seen considerable progress towards enabling users to enter 3D environments. Immersive headset 20a may for example use a combination of lenses, screens, and sensors to create a 3D experience that tricks the mind into believing the environment is real. Such a headset may include stereoscopic images in which headset or computer generates two flat images, one for each eye, which are then projected onto lenses in front of the eyes; motion tracking that tracks the user's head and eye movements, which are then reflected on the screen; and communication, including audio, to share information with others to create a realistic environment. The device may further include features such as haptic controllers that provide feedback, hand tracking that allows the user to interact with the virtual environment using their hands instead of controllers, and/or VR gloves. It is noted that typical VR applications have been focused on immersive environments and not logic-based solution environments, such as the present invention.

In one aspect, system 10 is integrated with immersive headset 20a to render and process logic solutions with 3D and 4D nodes that contain expressive information, formulae, conditions, and actions associated with physical objects. For example, users of a VR enabled device can step into virtual scenarios where bubbles (i.e., nodes) of arguments, evidence, data, and general information are conveniently viewable to the user and associated with physical parts or entire parts, geo locations, human agents, etc. In certain embodiments, a handheld controller 20b can be used to interact with the immersive headset 20a to, e.g., change views, create and edit solutions, etc.

In a further embodiment, a layered 2D+ environment 20c may be used to render layers of levels of 3D on a 2D screen to create 3D representations that enable causal reasoning and logic-programming with visual prioritization to subprograms, evidence, arguments, general information, etc. Specifically, the layered environment 20c provides a 3D rendering environment to create, edit, interact with, and view nodes that contain expressive information, formulae, conditions, actions, and more, in a layered configuration. This layered configuration displays dynamic visual information in the foreground versus background through time, giving the rendering a fourth dimension (4D).

In a further embodiment, a holographic technology platform 20d may be used to provide the 3D/4D environment. Integrations with a holographic platform 20d likewise renders solutions with 3D/4D nodes that contain expressive information, formulae, conditions, actions, etc., associated with physical objects. Specifically, in a holographic device-enabled 3D/4D environment, one can from a bird's eye view interact with bubbles (i.e., nodes) of arguments, evidence, data, general information. Such a platform 20d is conveniently viewable and manipulatable to the user and associated with physical parts of objects or entire objects, geo locations, human agents, and more.

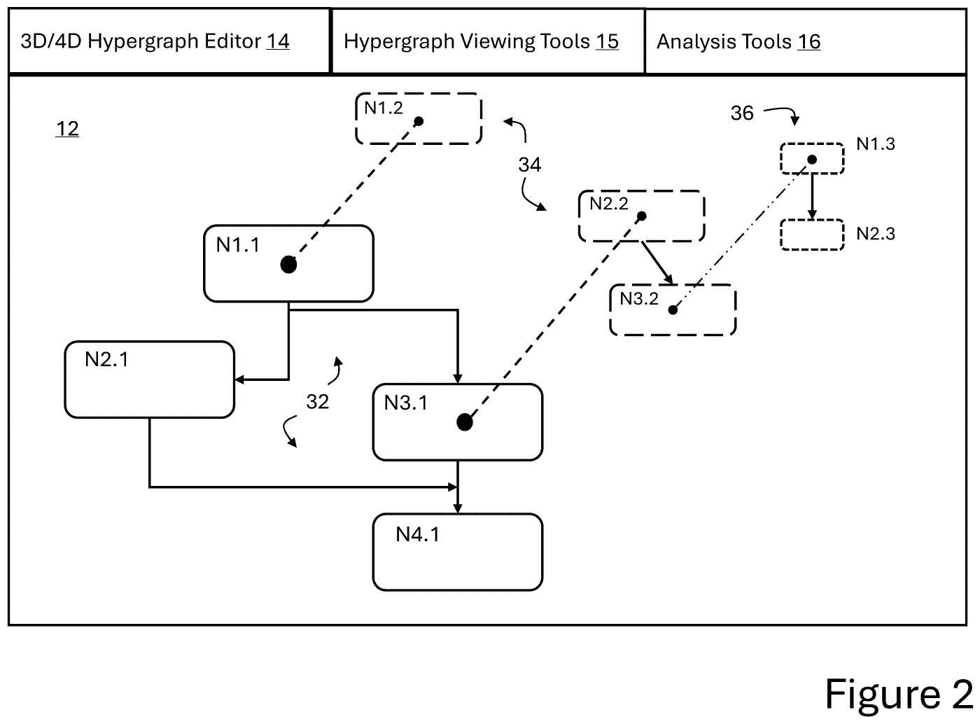

FIG. 2 depicts a generalized example of a 3D/4D visualization interface 12 rendered within a hardware visualization platform, such as a VR enabled device. Within interface 12, the user is able to access 3D/4D hypergraph editor 14 to create and edit solutions including constructing nodes, arcs (i.e., arrows) for connecting nodes, tools for creating new 3D levels, AI tools for autogenerating solutions or partial solutions, etc. The user is also able to interact with hypergraph viewing tools 15, which for example allows the user to navigate to 3D elements, interact and view a 3D hypergraph from different visual perspectives, limit views to certain nodes, etc. Once a hypergraph is created, the user can also deploy hypergraph analysis tools 15 to evaluate solutions, identify problems, bugs, etc. In certain embodiments, automated reasoning may be implemented by human users or AIs to answer queries, e.g., to determine whether a formula (in a node) can be reasoned-to or inferred from one or more other nodes (that likewise contain formulas. Automated reasoning includes logic solutions that allows a computer to reason completely, or nearly completely, automatically.

In the example shown in FIG. 2, a first set of foreground or primary nodes 32 are shown labeled as N1.1, N2.1, N3.1 and N4.1, which are arranged along an x-y axis. These nodes may for example form the main or primary trunk (or primary proposition) of the logic solution. A secondary set of nodes 34 are one level removed from the primary nodes 32, and connect to the primary nodes in the z-direction and are labeled as N1.2, N2.2, and N2.3. The secondary set of nodes 34 may for example be less important or weaker aspects of the solution (i.e., a secondary proposition), be aspects that are exceptions to the main solution, be aspects that are only relevant from a different perspective, etc. A further set of tertiary nodes 36 labeled as N1.3 and N2.3 are one level removed from and connect with the secondary nodes 34 in the z-direction, which may for example represent even less important or still weaker aspects of the solution.

Hypergraph viewing tools 15 allow the 3D hypergraph to be viewed from different 3D perspectives. For example, a user may want to only view secondary nodes N1.2, N2.2 and N3.2. In another case, the user may want to view only the first node at each level, N1.1, N2.1 and N3.1. In other cases, visual perspectives into the solution may be customized for a particular user, e.g., based on the user's role in an organization, based on user inputs, as determined by an AI, etc.

As noted, in certain embodiments, three-dimensionality can be used for example to put more important content in the foreground, and less important content in the background. In other embodiments, foreground vs. background schemes can be used for different purposes, e.g., to indicate the strength of formulas, or strength of inference links (arcs). That is, nodes with a formulae that have high semantic strength, e.g., a cognitive likelihood of CERTAIN, might be moved into the foreground, with other nodes of less semantic strength (e.g., UNLIKELY) receding to the background. The same treatment can be done with arcs (i.e., links, arrows), in which stronger inferences remain in the foreground and weaker inferences are moved to the background, e.g., when the inference in question is standard and deductive in nature (e.g., all dogs are animals), the arc could be shown in the foreground, and perhaps be made prominent as bolded/colored. Conversely, inferences that are less standard or deductive (all big dogs like cats), may connect to nodes in the background. In other cases, more attention may need to be paid to the weaker/less plausible formulae, so things could be reversed, in which weaker formulae are brought to the foreground, where further attention from humans is possible.

The present approach accordingly is extended beyond deductive reasoning to non-deductive reasoning in which formulae are not simply true or false, and inferences do not simply preserve truth as they are made. A description of this concept and approach is provided, e.g., in (Bringsjord et al. 2024): Bringsjord, S., Giancola, M., Govindarajulu, N. S., Slowik, J., Oswald, J., Bello, P. & Clark, M. (2024) “Argument-Based Inductive Logics, With Coverage of Compromised Perception’”Frontiers in Artificial Intelligence. 6:1144569. DOI:https://doi.org/10.3389/frai.2023.1144569, which is hereby incorporated by reference.

Instantiation of the visual interface may be implemented with an object-oriented framework that uses code units. Nodes, arcs, classes, functions, templates, as well as files or tabs used in the editor may generally be referred to as code units. Positioning of code units within the 3D environment can be implemented manually by the user or automatically by an algorithm such as a large language model. Factors used in position code units within the 3D environment may include, e.g., uncertainty or probability associated with code unit, difficulty of construction of the code unit, relevance of the code unit to the task at hand, complexity of the code unit (e.g., cyclomatic complexity), frequency of use of the code unit, test coverage of the code unit, bugs associated with the code unit, another other metric selected by the user, viewing perspectives required, etc.

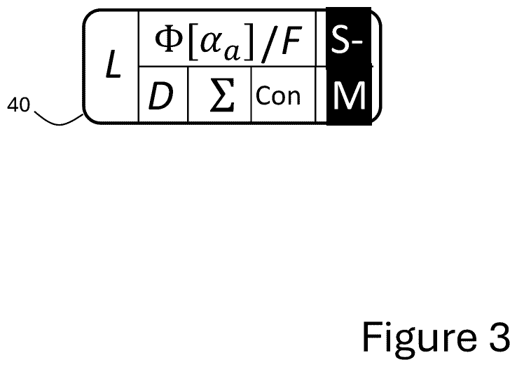

FIG. 3 depicts an example anatomy of a node 40 used in a 3D/4D hypergraph representation. Node 40 includes a label (or name) L, which, e.g., can be phrase or sentence, etc., includes an individual formula ϕ or set Φ of formulae in one or more of the available formal languages, and may include meta-formulae. In some cases, instead of a formula/formulae, the node may comprise one or more functions F, specified in an underlying functional programming language (e.g., Clojure) that makes function symbols in the formulae Φ “live.” E.g., there might be a formula that says that x multiplied by 1 returns x, as in ∀x (x×1=x), and multiplication here is implemented in an underlying function.

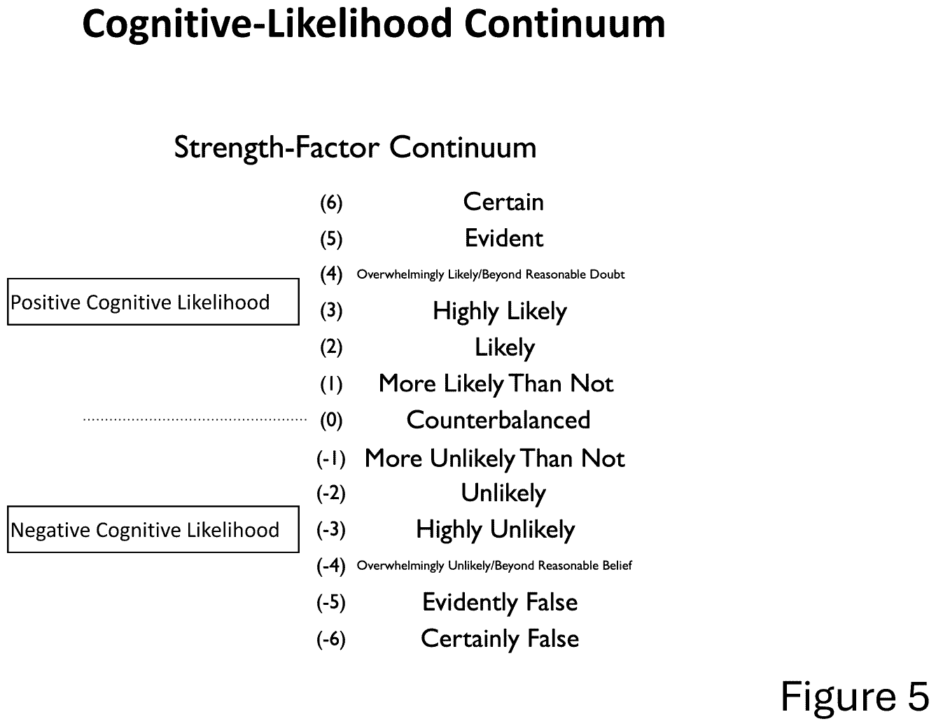

Node 40 may further include dependencies D, which are other nodes the present one depends upon (in some cases to degrees indicated by visual information in 3D and 4D form). Σ is the “semantic value” of the formula/formulae. If a classical bivalent=2, then valued underlying logic is being used, Σ would be either TRUE or FALSE; if a trivalent=3, then valued underlying logic is in play, Σ could one of the values TRUE, FALSE, INDETERMINATE. If cognitive likelihood is being used, then Σ can take on any of the values shown in the spectrum 48 given in FIG. 5, below.

Node 40 may further include a context Con. Information here includes whether the node is being used in a proof for one or more goals that an agent aims at proving/supporting, i.e., is the node exploratory. S-expressions, and comments C that underlie what is shown in normal display, i.e., this content is analogous to source code and comments in computer programs and the source-code level. S-expressions and comments here can be revealed, e.g., by double clicking. Metadata M, includes human annotated and machine generated information. Metadata can, e.g., include author(s), time added/edited/proof difficulty/stability, etc.

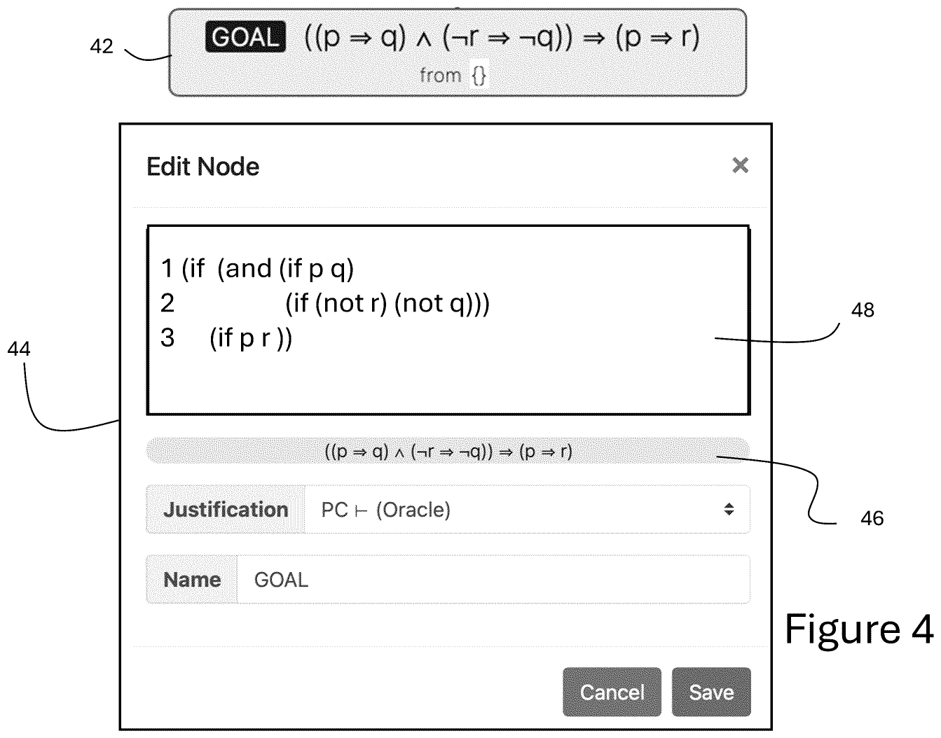

FIG. 4 depicts an example of a node 42 labeled GOAL and an associated node editor 44 for creating the node. In this case the node includes a formula involving propositional calculus, which is a theorem that has been proved by one of the AI oracles able to find proofs on its own. The underlying S-content is shown in window 48 (which is automatically generated) when the formula is entered into window 46. As noted, other nodes may include functions, such as f (x,y)−>((3*x)−(2*y)), which is a binary arithmetic function, i.e., is a simple polynomial taking in a number x and a number y.

FIG. 5 depicts an overview of an illustrative cognitive continuum or spectrum, which can be for the case where Σ is based on cognitive likelihood, and Σ can take on any of the 13 values shown in the spectrum shown here. This is a continuum ranging from the proposition in question believed by a rational agent to be certainly false (e.g. that 2+2=45 in base 10 is believed by such an agent to be certainly false), on up to the belief on the part of such an agent that a certain proposition is certain (e.g., that 2+2-4). Other cognitive likelihoods between these two endpoints may for example include beyond reasonable doubt (central in some legal and investigative arguments), and counterbalanced. The latter is agnosticism with respect to a proposition.

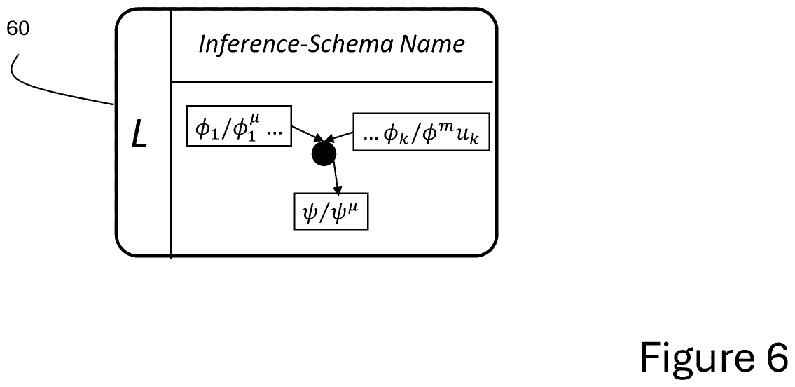

FIG. 6 depicts an example of an inference schema type node 60. This says that from a formula that is a conjunction, one can infer either of the conjuncts. The specification of the schema is expressed as a meta-hypergraph itself. This information makes the entire edifice of a logic solution recursive, since the call of an inference schema to sanction an inference holds within it the specification of the schema itself. These nodes 60 are the other “building blocks” (along with formula nodes) of the larger structures (PGLPs, proofs, arguments—in the form of 2D, 3D, and 4D hypergraphs. In the 2D case, they are rectangles; in the 3D and 4D case, they may be dodecahedrons. When the nature of an inference schema node 60 can be left unspecified and abstract, they are simply black circles in 2D, and dodecahedrons in the 3D case without any internal structure/content shown. Every time an inference takes place, there is a link going from one or more formulae/function nodes, to an inference-schema node, and then to one or more formulae/function nodes.

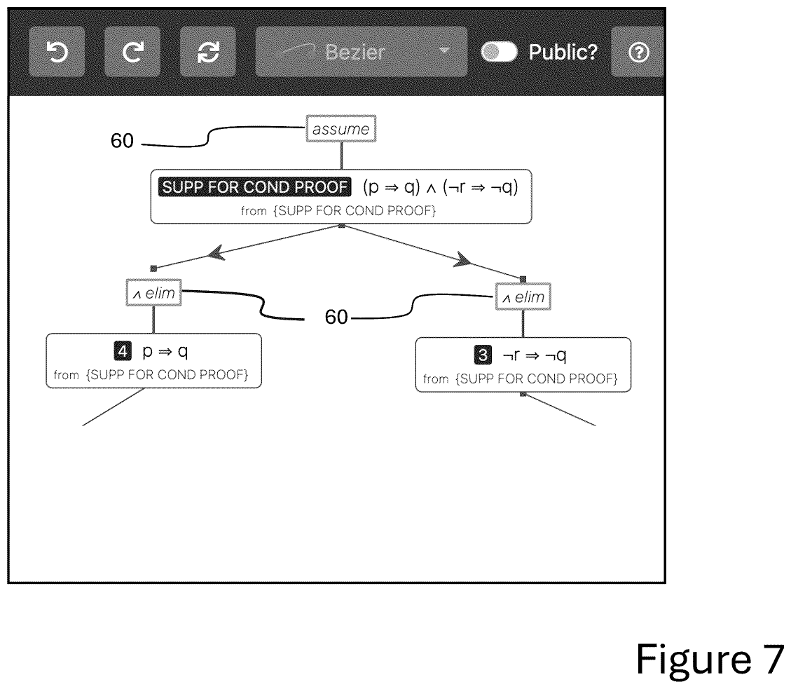

FIG. 7 depicts inference schematic nodes 60 used in a proof. A simple type shown is referred to as an Assumption node “assume” (used to put assumptions or suppositions into the workspace), and the other inference schemas are called A Elimination nodes “elim,” which allows for the inferring of individual conjuncts from conjunctions. This example involves three inference-schema nodes 60 (the smaller rectangles), and three formula nodes (larger rectangles). The first inference is an assumption (hence the top-most assume node), which is a formula in the propositional calculus. The formula is a conjunction of two conditional statements, on the left that p implies q (or, if p then q), and on the right that not-r implies not-q (or, if not-r then not-q).

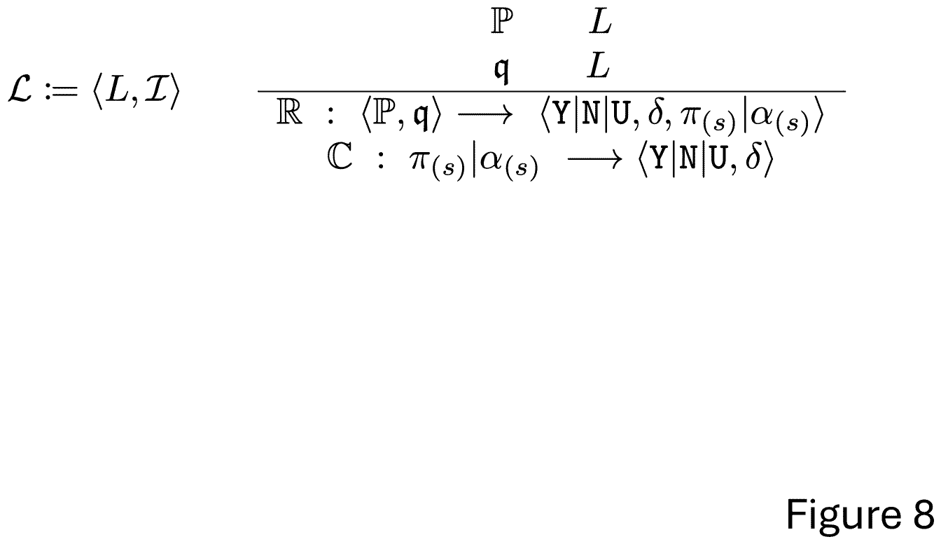

FIG. 8 depicts an abstract, symbolic encapsulation of the elements that compose Pure General Logic Programming (PGLP). The three main elements shown in this figure are: [symbol] , a program; [symbol] , a reasoner; and [symbol] , a checker. The various elements of the framework are explained in the figure itself. Content above the horizontal line is created by the programmer, and is as follows. L is the background formal language in which both the program [symbol] and query q are expressed. This is the underlying logic in play. It is composed of two items, a formal language L, and a collection of inference schemata/that specify what inferences are allowed. The reasoner [symbol] takes as input (the content to the left of the right-to-left arrow) a pair composed of the program [symbol] and query q. That which is returned is to the right of the left-to-right arrow, three things (within the angled brackets): First, an answer to the query of Y (yes), N (no), or U (undecided). Second, the degree δ of confidence the reasoner has in its verdict. And third, if appropriate, a proof π or argument α in justification of the verdict rendered. The checker [symbol] takes in the proof π or argument α, checks it, and renders a verdict of Y (yes, valid), or N (no, invalid), or U (undecided), along with the degree δ of confidence the checker has in its verdict. Elements of the underlying formal language may include “degree of confidence”, proofs, and arguments.

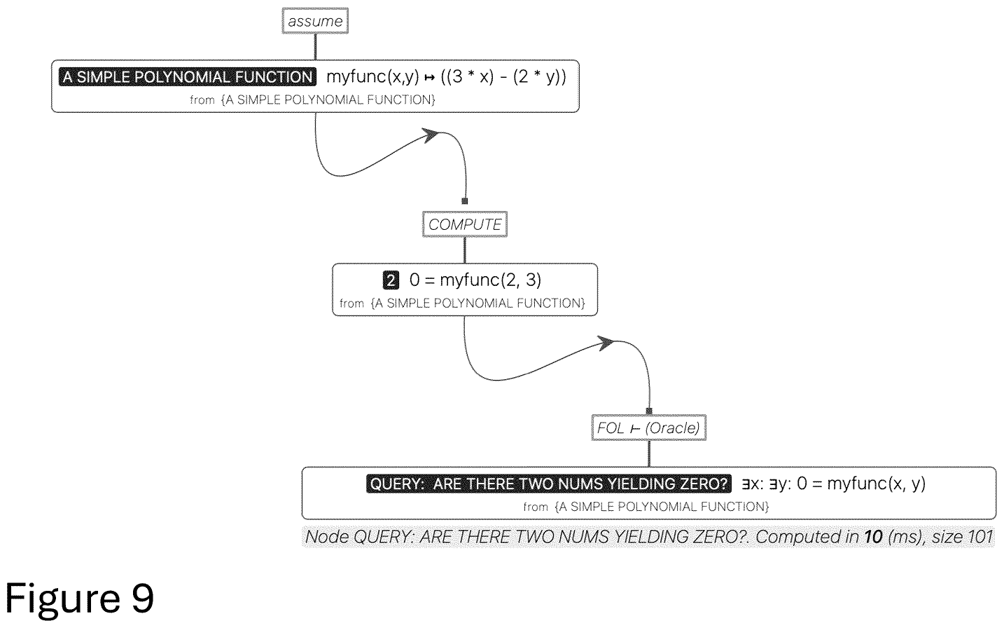

FIG. 9 depicts a simple 2D Pure General Logic Program (PGLP) at the Level of First-Order Logic. The program [symbol] here is composed of an assumption that defines the function myfunc, and then an inference to a simple formula that says that zero equals the result of myfunc applied to 2 for x and 3 for y. The query q issued in this figure by the programmer: Does there exist an x and a y such that the function myfunc applied to x and y yields zero? The answer given is Y (yes), since the query succeeds, taking the AI only 10 milliseconds to find a proof that certifies the affirmative.

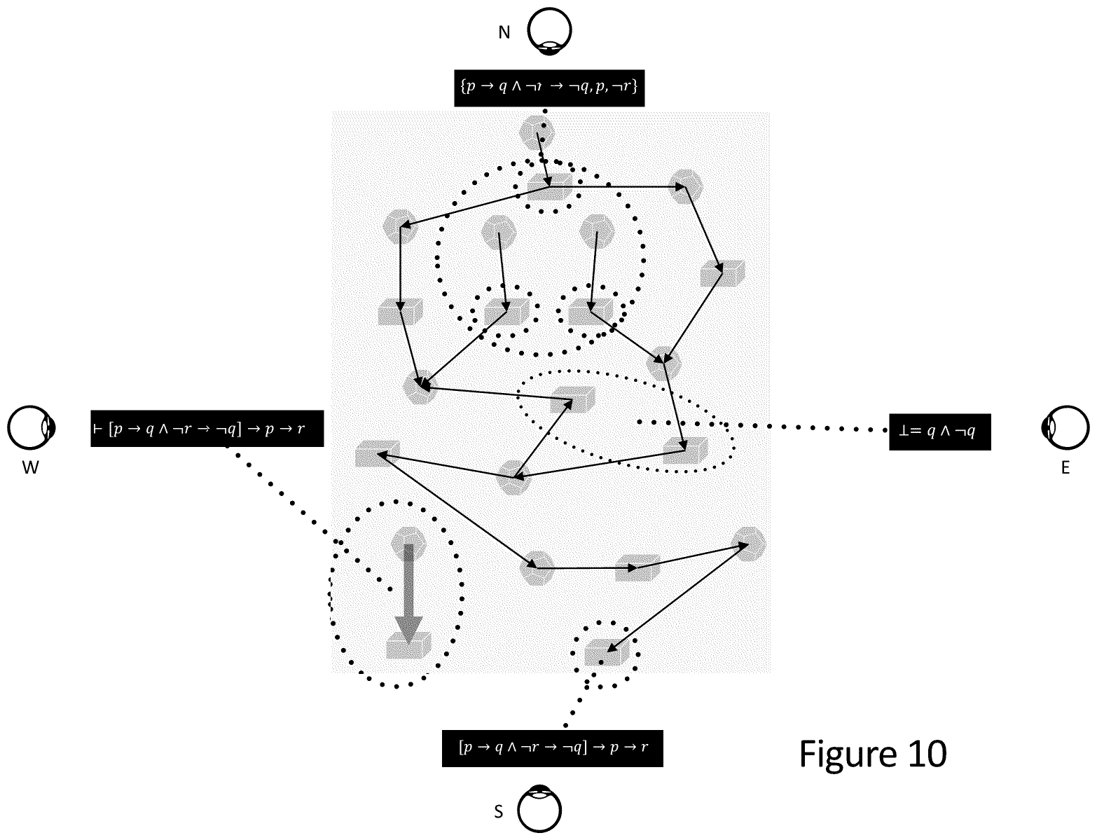

FIG. 10 depicts an illustrative 3D proof. In this case, four different agents interact with a three-dimensional proof; each agent has a different focus-of-attention (FOA) or perspective in that proof, at the timepoint depicted here. The proof in question is one shown above. Each FOA is automatically brought into perceptual prominence by moving into the foreground of the point-of-view of the relevant agent. Agent S (South) is at this timepoint focused on the goal formula that is ultimately reached in the proof. Agent W (West) has its focus on the result of a call to the oracle for the propositional calculus, which succeeds in proving the goal formula on its own, without human assistance. Agent E sees the contradiction exploited in the indirect sub-proof. Agent N views the underlying 3D hypergraphical proof. This visualization can be embodied via VR (or other visualization platform such as augmented reality AR) technology (which is indicated by the goggles), in which multiple users view the 3D solution.

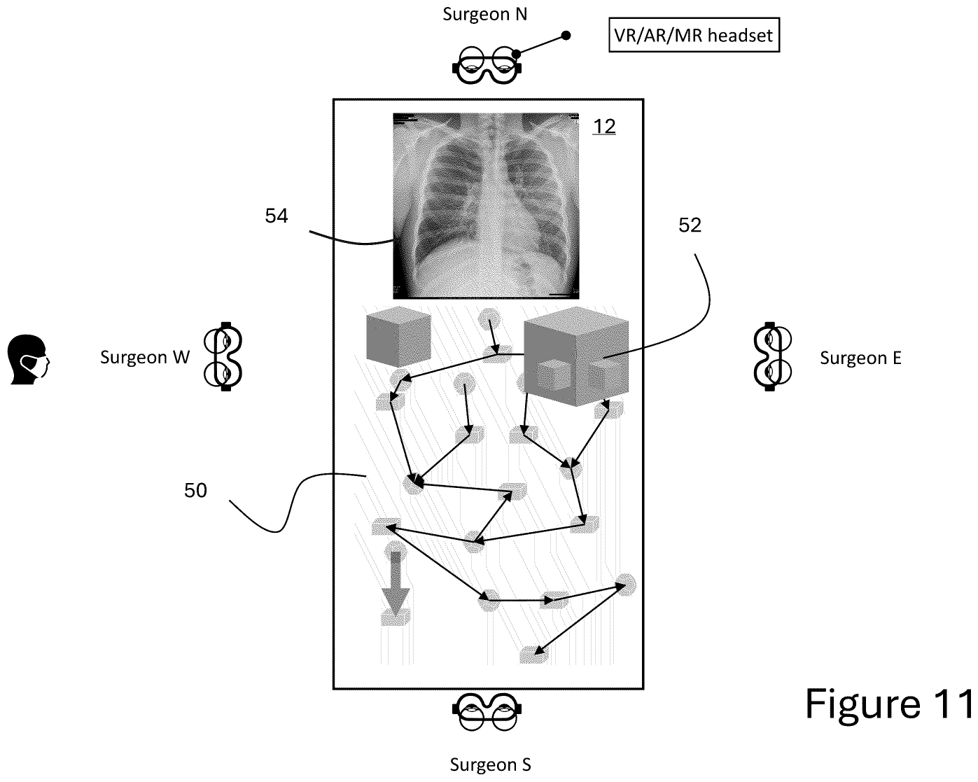

FIG. 11 depicts an example of a visualization interface 12 using augmented reality (or VR, holography or MR) surgical planning meeting that leverages a 3D hypergraphical argument 50. A radiological scan of a patient is included. Surgeons can interact with the argument 50 and scan 54 using a VR, AR or MR headset—or holography interface. (Note that if AR or MR is used, the surgeon could view an actual scan, and if VR is used, the scan could be a simulation). In this case, an argument 50 is provided that expresses that a procedure P is optimal, as posited by a Surgeon S. Different surgeons may view the argument from different 3D perspectives, that are most relevant to themselves. For example, Surgeon N may only be interested in the diagnosis portion of the argument 50 based on the scan 54 and thus may only view a first subset of the nodes. Surgeon E may be focused on a knowledge base 52 from which different treatment plans reside and thus may only view a second subset of the nodes, etc.

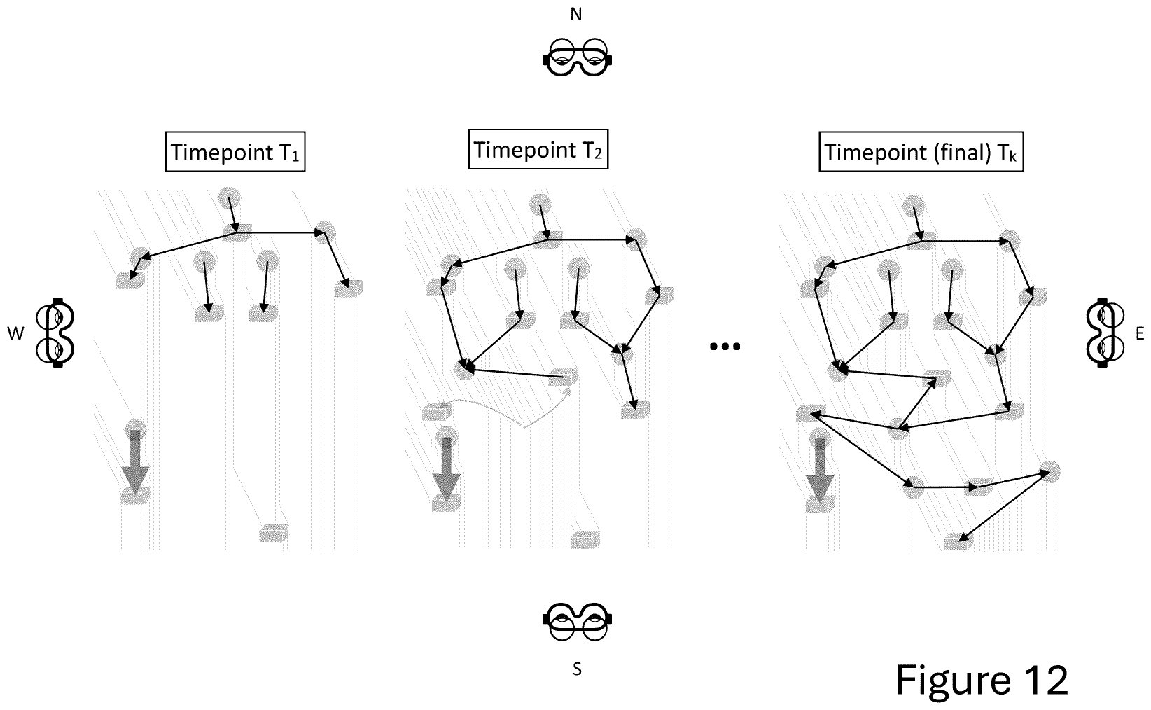

FIG. 12 depicts a 3D hypergraphical proof built and viewed through time (4D) by multiple users. In this cases, the solution evolves over time, and the goal is finally proved at the final timepoint Tk.

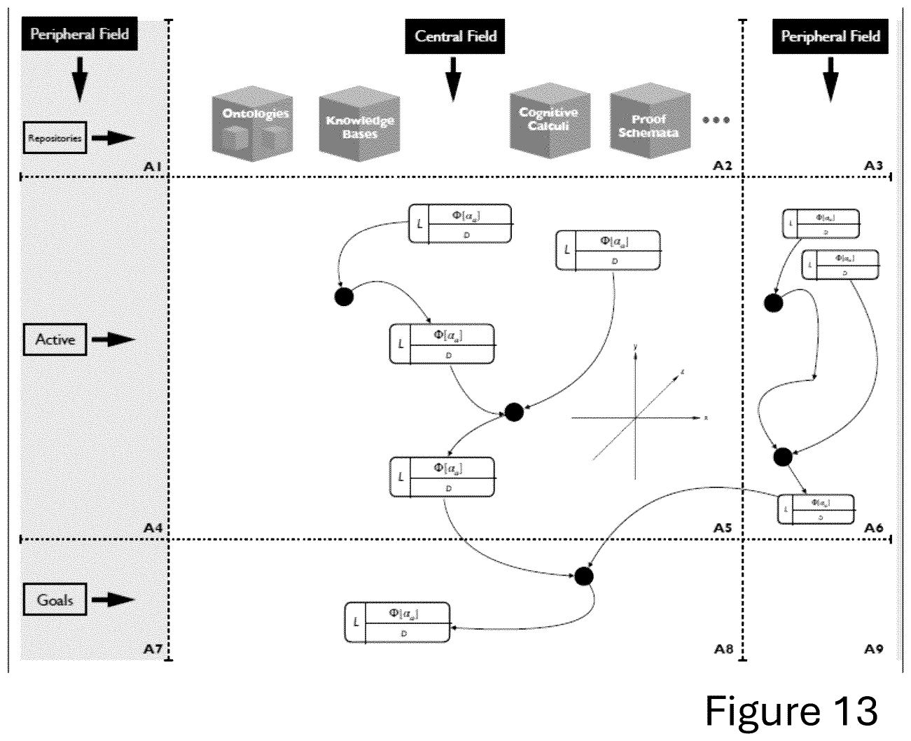

FIG. 13 depicts an illustrative 3D visualization. The user's 3D view has nine areas. There is a center field, A5, the middle section of which holds content that is the chief focus of attention, in the processing of proofs, arguments, logic programs, as for example discussed in U.S. Pat. No. 11,526,779, which showed a simple hypergraphical proof in two-dimensions (=2D). Areas A4 and A6 are, respectively, peripheral fields in which content is left of the x axis, and then into the background along the y axis. A top row of areas, A1-A3, is devoted to offering resources that may be used for the problem-solving activity taking place at the moment. A bottom row of areas, A7-A9, is where the objectives of problem-solving activity are depicted, with the chief goal/s appearing in area A8, and sub-goals appearing in A7 and A9. The black dots denote inference schema, instantiated.

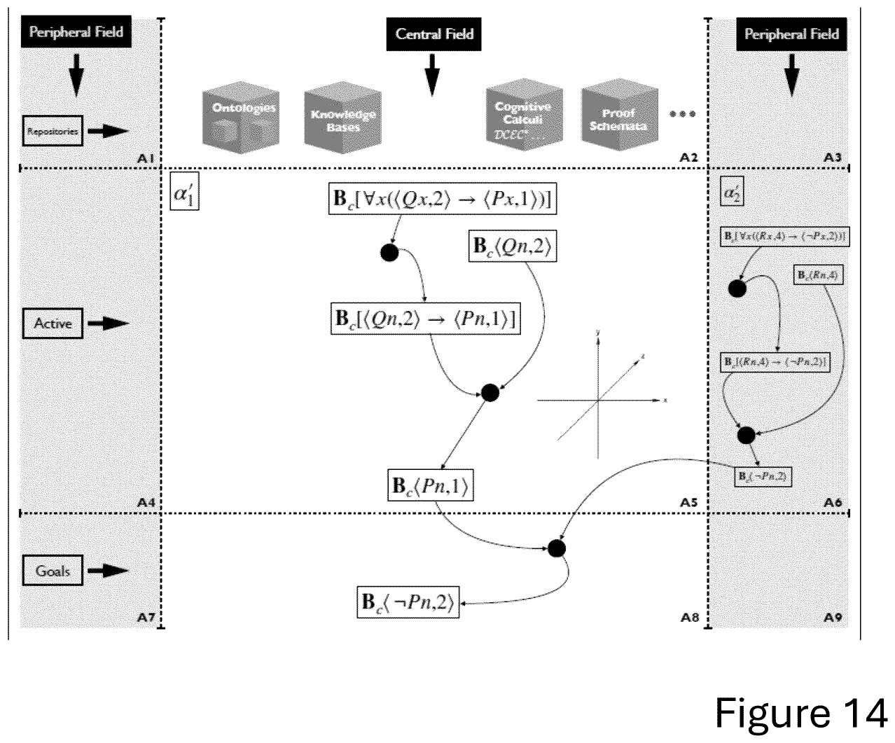

FIG. 14 shows an example in which the 3D interface has been instantiated with two particular arguments, one in the center area A5, and another in area A6. The goal is obtained and shown in area A8. The level of logic used here (where “level” means what it has meant in U.S. Pat. No. 11,379,732), is Level 6. The symbol B denotes belief.

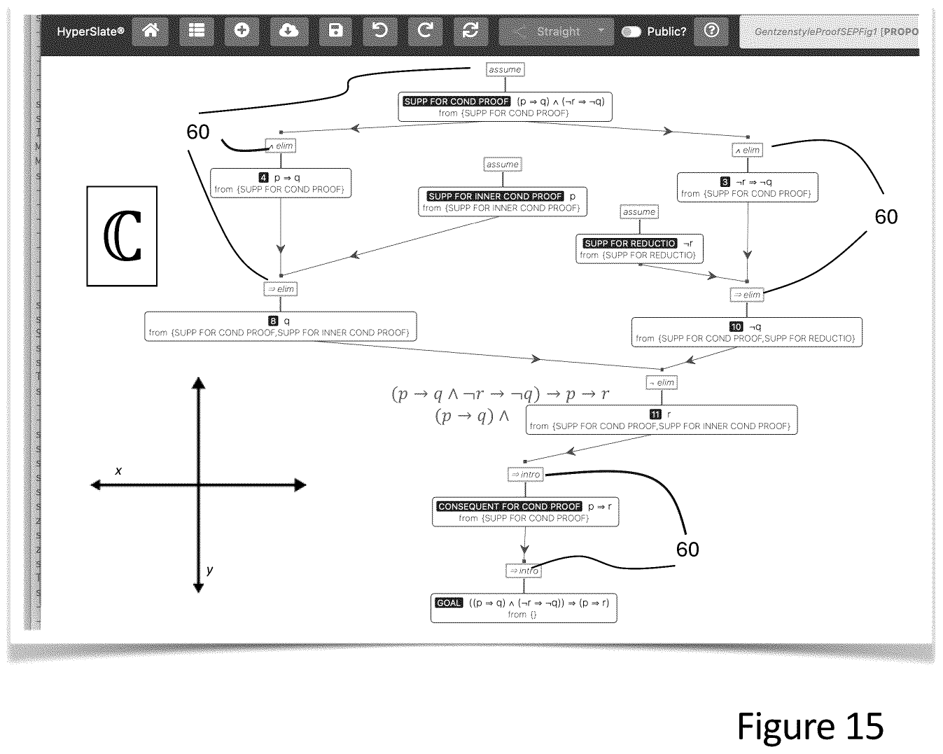

FIG. 15 depicts a 2D hypergraphical proof of a popular-for-exposition theorem in propositional calculus. The commonly used theorem in the propositional calculus in order to explain the standard forms of natural deduction is herein proved. The theorem says that if p implies q, and not-r implies not-q, then p implies r. The checker C indicates that the analysis system, i.e., AI checker, has been deployed; it checks each claimed inference to ascertain whether or not it is valid. In some embodiments, inference nodes 60 may be color coded (red or green) to indicate whether in inference between nodes is correct. In this case, every inference node 60 would be green indicating that all the inferences have been checked and verified as correct. Notice that this proof is in two dimensions: only the x and y axes are used.

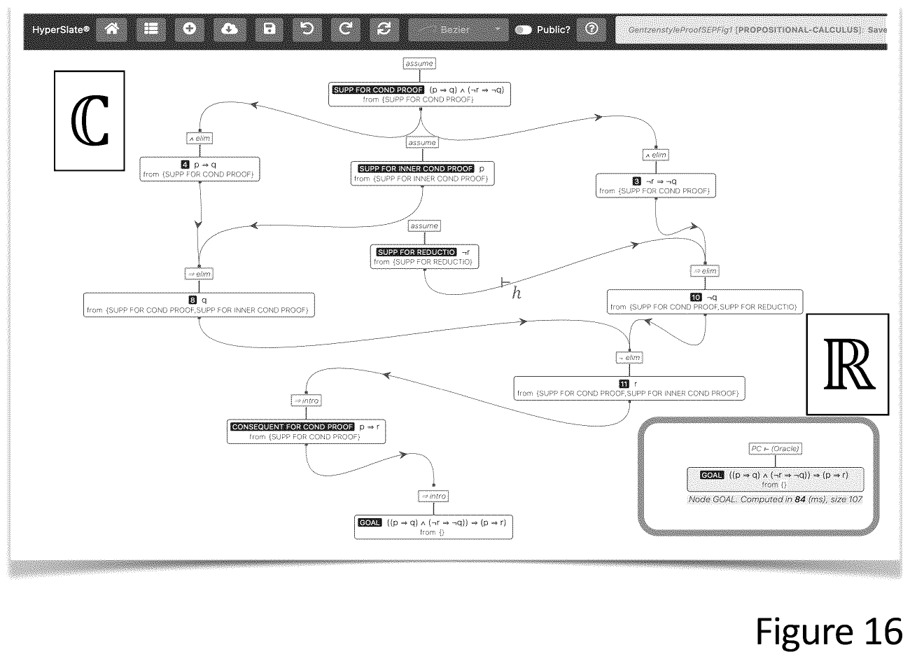

FIG. 16 depicts a slightly different proof. The interface still shows a hypergraph, but it is not a connected one, since the formula node in the bottom right corner stands on its own, no arcs from it or to it. R here indicates that the AI automated reasoner, an “oracle,” has been called, and has automatically found a proof of the theorem in question. The inference schema used (and announced) here, “PC oracle,” is one in which the automated reasoner for the propositional calculus is called, and used. Notice that this proof is still in two dimensions: only the x and y axes are used.

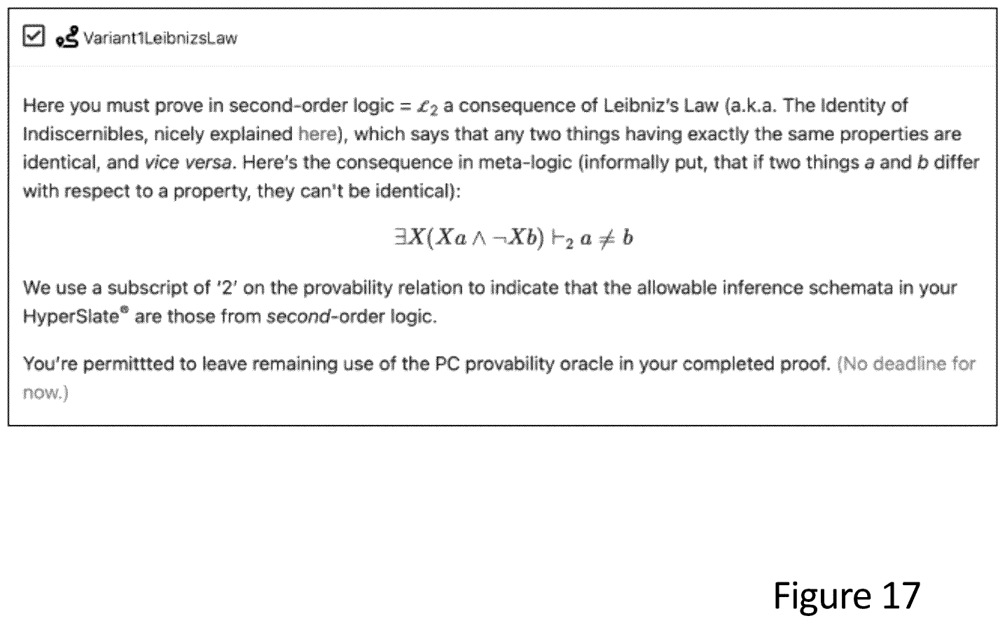

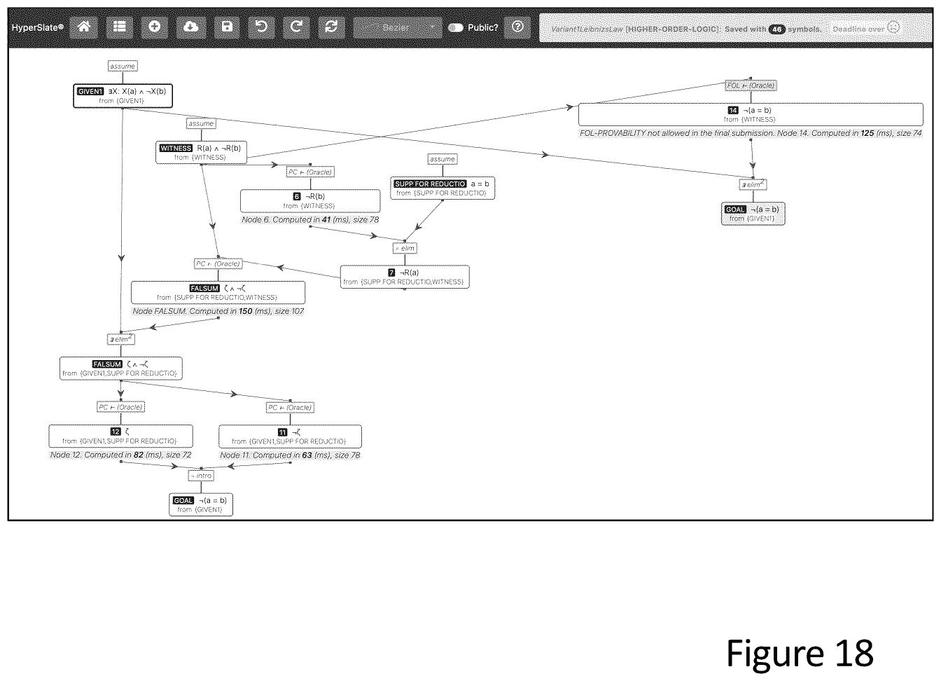

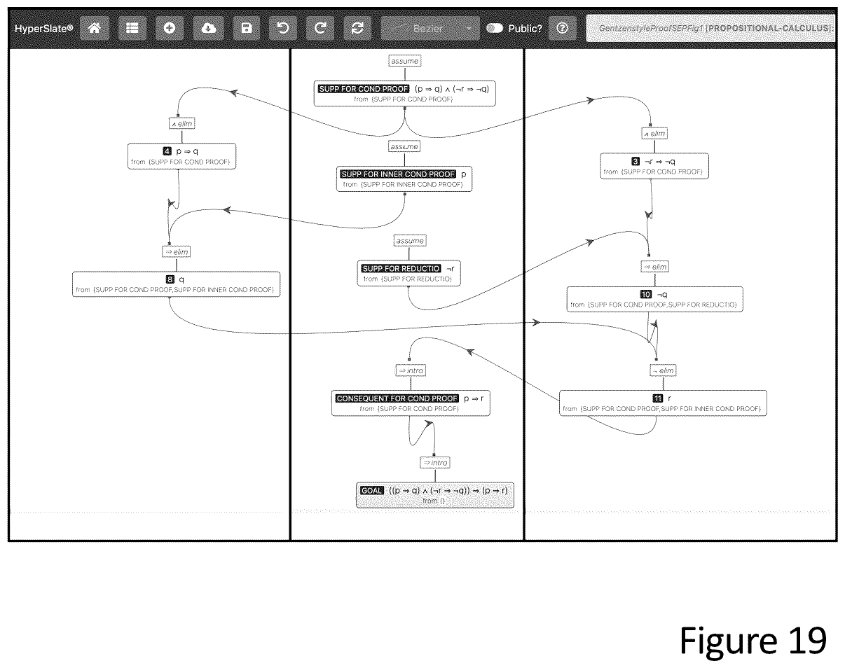

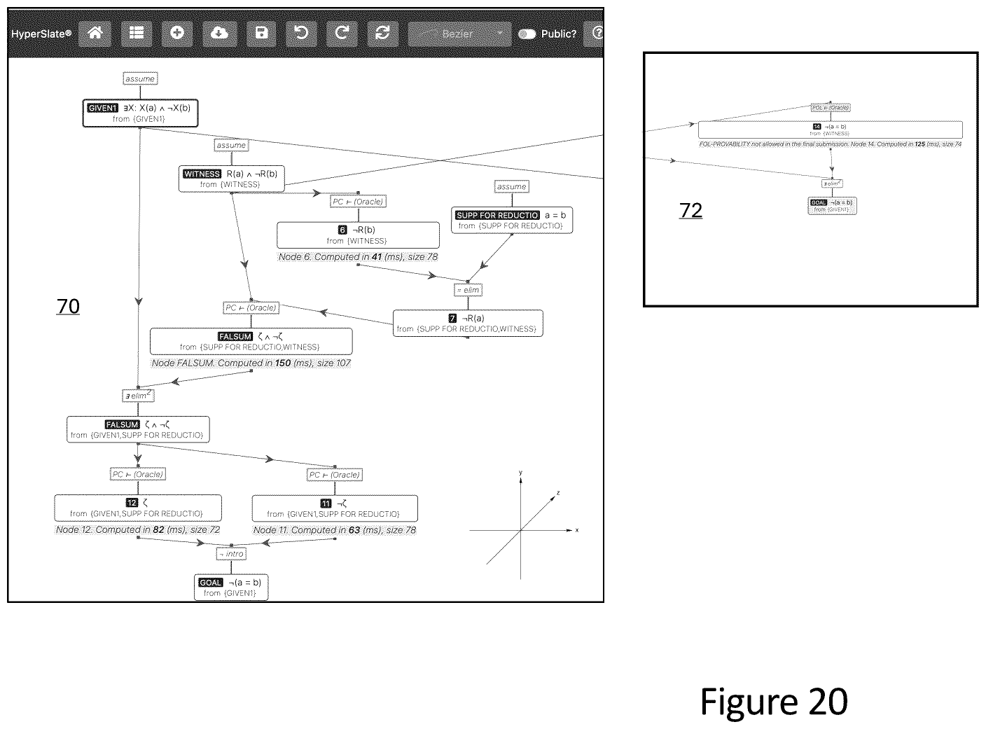

FIG. 17 depicts an illustrative proof problem. The problem here is to construct a proof that confirms that if there exists a property X which a has but b doesn't, a and b can't be the same thing. FIG. 18 shows the problem being solved with a proof in 2D. Here we have a proof in second-order logic. The theorem, which goes back to Leibniz, is straightforward; it says that if there is a property X object a has, but object b doesn't have, then a and b cannot be the very same thing. Notice that this proof is in two dimensions: only the x and y axes are used. FIG. 19 shows the proof being translated to 3D. The center area shows the main “backbone” of the proof in question. Inferences outside this central part are subsidiary, in the sense that once one arrives at the main moves in the backbone, the remainder in the two peripheries becomes a challenge that is easier to meet than devising the central plan. The content to the left and right of this central content, two sub-proofs, is moved along the x axis: left sub-proof the left on that axis; right sub-proof to the right on that axis. In this case, each sub-proof can be moved into the background, along the z axis. FIG. 20 shows an example of a proof 70 with one sub-proof 72 removed from the main view, i.e., set back along the z-axis in a different view.

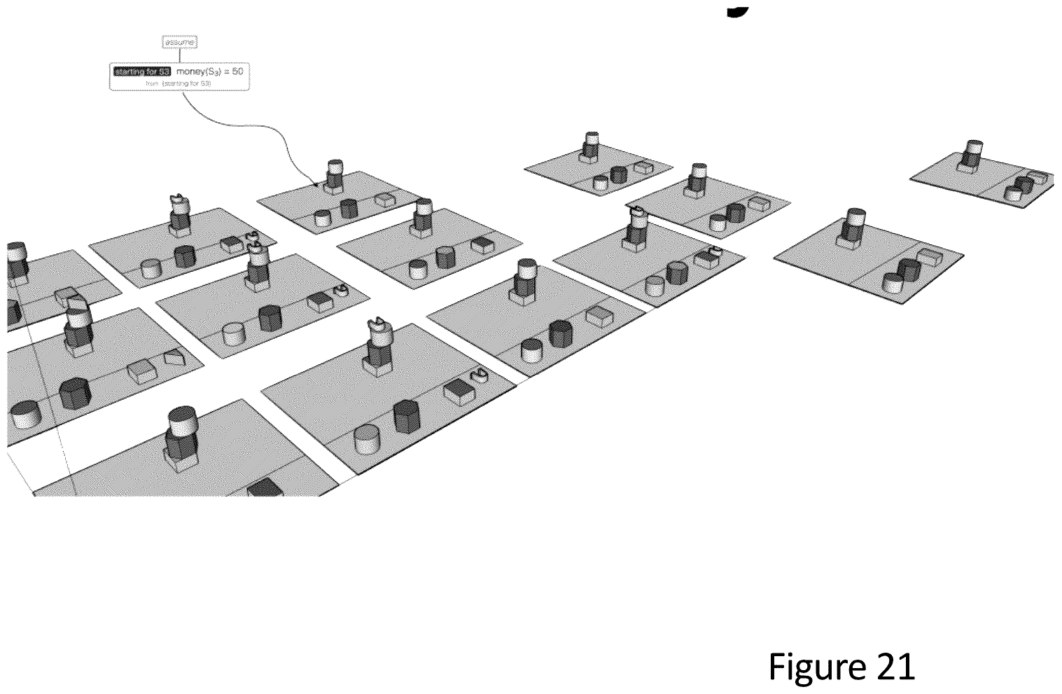

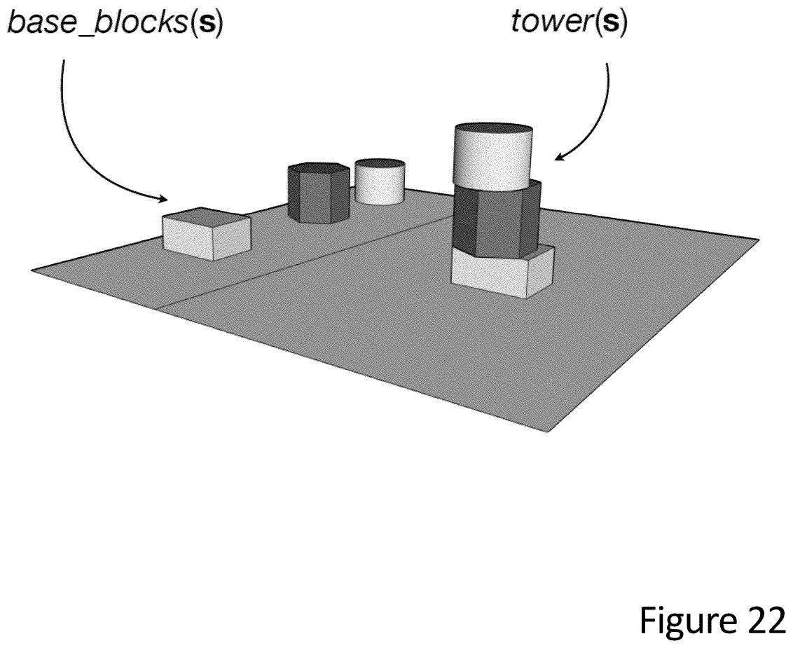

The described system 11 can also be applied to, e.g., Turing-complete Games, i.e., 3D games of arbitrary complexity with/without logic and code nodes interacting with game mechanics, in which computations can be simulated. Every precisely defined 2D or 3D or 4D game of reasoning can be cast as a series of challenges in the provided hypergraphical environment, based on a selected logic; these challenges can be met by human-AI action in that environment, to construct proofs and/or arguments and/or pure general logic programs. For example, FIGS. 21 and 22 depict an example game referred to as Babel's city. In Babel's city, the goal is to construct identical towers in each city square. There are a finite number of city squares S laid out on a plane. A building block is an instantiation of a 3D painted shape. A tower is defined as a vertical sequence of building blocks. Each square s has the ability to manufacture an unlimited number of tower building blocks of a given fixed set of shape and colors: base_blocks(s). Each square s has a limited amount of money: money(s). The money can be used to buy blocks from immediate neighbors at a rate set by the neighboring square. Blocks can be purchased from far away squares, but any squares on the way from seller to buyer can add a tax for transit of blocks through them. The tax depends on number of items transported. Therefore, before the transportation process, blocks can be merged for efficient transport. Merged blocks can't be separated. The goal is to construct a tower in each square such that the towers in all squares look the same (identical sequence of blocks).

Consider a single tower in Babel's City. Assume the tower is composed of a base regular rectangular prism, then a regular hexagonal prism, and then on top a cylinder. This is the tower shown in the square depicted in FIG. 22. Each block in this tower is itself a formula. For example, the formula corresponding to the hexagonal prism is one that says in formal logic that there exists a regular hexagonal prism at such and such a location in space, of such and such size, with a cylinder immediately atop it, and rectangular prism immediately below it. A player of Babel's City is perceiving, understanding, and manipulating spatialized formulae-all without a single symbol in play. And since this is happening through time, dynamically, a 4D environment is here showing that formulae traditionally spelled out with symbols can be transformed when moved to n-dimensional environments.

The present approach provides a more formal, general scheme for the 4D-ification of formulae in logics. Consider the formula node shown 42 shown in FIG. 4. This formula has a length, measured by the number of symbols used (31). Assuming the symbol set from which the formula is built have a fixed width, the formula now has a width suitable for showing in a simple 2D world of basic geometry. But even in the case of this very simple formula, there are many aspects that can be rendered spatially. The height of the formula corresponds to a tree that tracks the construction of the formula in accordance with the underlying grammar for the propositional calculus. For instance, first start with p alone; it is a grammatically valid formula. Next, obtain q alone, also valid. Next, build the conditional p=>q. Now, do the same kind of thing to get not-r=>not-q. Next, conjoin these two conditionals; this gives you the antecedent of the overall conditional. The depth of a formula corresponds to the complexity of the level of nesting of Boolean operators in a formula, along with their variety. The result is that the geometric sizing and shape of a formula node, in 3D, has supplanted the symbolic scheme that has been in place for centuries.

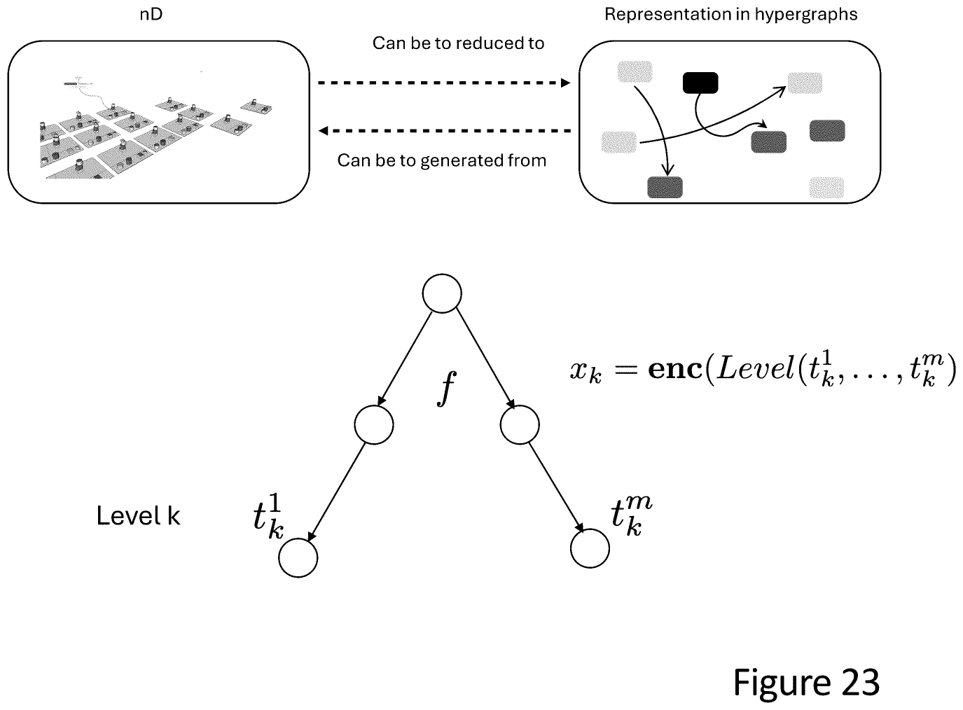

Accordingly, any n-dimensional (nD) reasoning-based game can be represented using hypergraphs with an appropriate logic. The representation process provides that nodes/formula become objects and their positions in nD space. The logic system and axioms described herein become the game mechanics, rules and constraints in the game. For example, each node N can be positioned spatially in n dimensions as follows N<-> (x₁, xₙ, . . . xₙ). Note that the Gödel numbering function enc encodes any formulae as a unique natural number. Each node contains a formula f, and each formula is a tree t of arbitrary depth. Items in t at a depth k form the kth coordinate through a function Level and the Gödel numbering function enc as shown in FIG. 23.

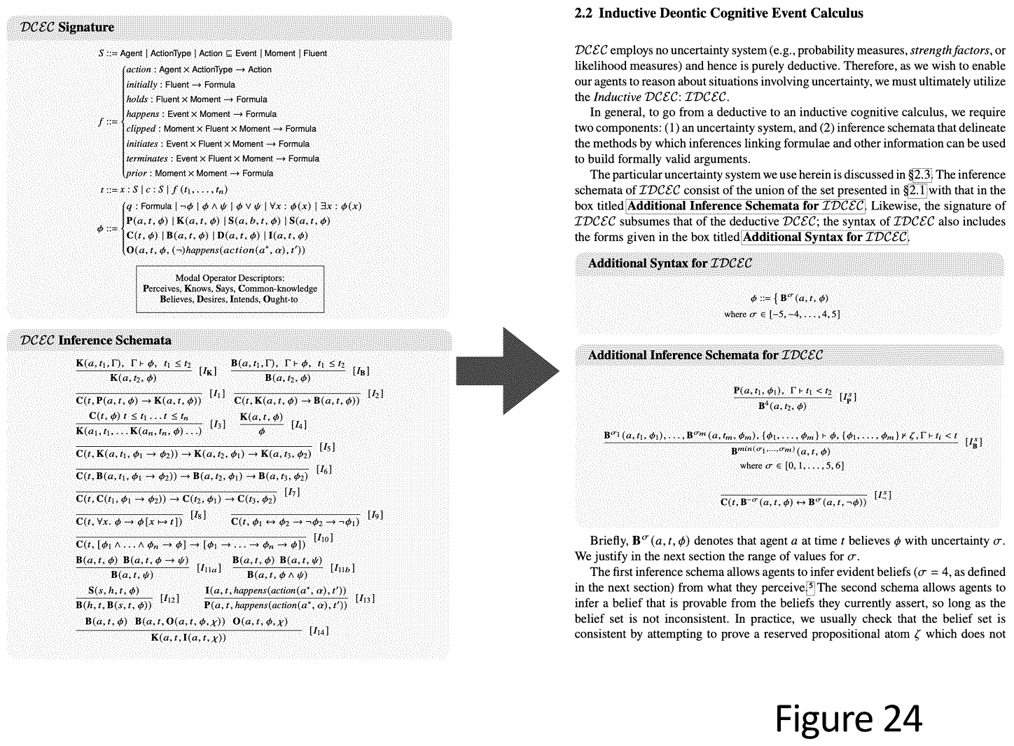

FIG. 24 depicts an illustration of how formal deductive cognitive event calculus (DCEC) can be presented as an inductive deonetic cognitive event caclulus.

It is understood that aspects may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

An illustrative computing system may comprise any type of computing device and for example includes at least one processor, memory, an input/output (I/O) (e.g., one or more I/O interfaces and/or devices), and a communications pathway. In general, processor(s) execute program code which is at least partially fixed in memory. While executing program code, processor(s) can process data, which can result in reading and/or writing transformed data from/to memory and/or I/O for further processing. The pathway provides a communications link between each of the components in computing system. I/O can comprise one or more human I/O devices, which enable a user to interact with the computing system. Such a computing system may also be implemented in a distributed manner such that different components reside in different physical locations.

Furthermore, it is understood that the described system or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to an individual in the art are included within the scope of the disclosure as defined by the accompanying claims.

1. A three dimensional (3D) logics visualization system, comprising:
an immersive headset configured to visualize a 3D environment; and
a system for rendering and processing logic solutions within the 3D environment, the system including:
an editor for creating a 3D hypergraph that represents a logic solution to a reasoning problem, wherein the 3D hypergraph includes nodes connected by arcs arranged in an x, y, and z dimension; and
an interface manager for viewing the 3D hypergraph from different perspectives.

2. The system of claim 1, wherein the immersive headset comprises a virtual reality (VR) enabled device.

3. The system of claim 1, wherein the logic solution includes one of a proof, argument or computer program.

4. The system of claim 1, wherein nodes of the hypergraph include formulas represented with cognitive calculus.

5. The system of claim 5, further comprising inference nodes.

6. The system of claim 1, wherein the system for rendering and processing logic solutions further includes a temporal dimension processor configured to display logic solution over a time period.

7. The system of claim 1, wherein the 3D hypergraph includes:
a primary proposition represented by a primary set of nodes and arcs viewable in a first x-y plane; and
a secondary proposition represented by a secondary set of nodes and arcs viewable in a second x-y plane offset from the from the first x-y plane along a z-axis.

8. The system of claim 7, wherein the primary proposition has a greater importance or strength than the secondary proposition.

9. The system of claim 1, wherein viewing the 3D hypergraph from different perspectives includes viewing a subset of the nodes.

10. The system of claim 1, wherein system for rendering and processing logic solutions includes:
a checker that checks inferences for validity; and
a reasoner that evaluates a program and a query and returns an answer to the query and a degree of confidence.

11. A three dimensional (3D) logics visualization system, comprising:
a visualization platform configured to visualize a 3D environment; and
a system for rendering and processing logic solutions within the 3D environment, the system including:
an editor for creating a 3D hypergraph that represents a logic solution to a reasoning problem, wherein the 3D hypergraph includes nodes connected by arcs arranged in 3D space; and
an interface manager for viewing the 3D hypergraph from different perspectives;
wherein the 3D hypergraph includes nodes and arcs, wherein each node includes one of a formula or a function, and each arc includes an inference.

12. The system of claim 11, wherein the visualization platform comprises one of a virtual reality (VR) enabled device, an augmented reality (AR) enabled device, a layered interface, or a holographic system.

13. The system of claim 11, wherein the logic solution includes one of a proof, argument or computer program.

14. The system of claim 11, wherein nodes of the hypergraph include formulas represented with cognitive calculus.

15. The system of claim 11, wherein the 3D hypergraph includes:
a primary proposition represented by a primary set of nodes and arcs viewable in a first x-y plane; and
a secondary proposition represented by a secondary set of nodes and arcs viewable in a second x-y plane offset from the from the first x-y plane along a z-axis.

16. The system of claim 15, wherein the primary proposition has a greater importance or strength than the secondary proposition.

17. The system of claim 11, wherein viewing the 3D hypergraph from different perspectives includes viewing a subset of the nodes.

18. The system of claim 11, wherein system for rendering and processing logic solutions includes:
a checker that checks inferences for validity; and
a reasoner that evaluates a program and a query and returns an answer to the query and a degree of confidence.

19. A logics visualization system for implementing an n-dimensional (nD) game, comprising:
an immersive headset configured to visualize an nD environment; and
a system for rendering and processing logic within the nD environment, the system including:
an editor for creating a nD hypergraph that represents a series of challenges based on a selected logic, wherein the nD hypergraph includes nodes connected by arcs arranged in the nD environment;
an interface manager for viewing the nD hypergraph from different perspectives; and
a system for generating a game based on the nD hypergraph, wherein each node comprises a formula that defines an object and a position into nD space, and wherein the selected logic includes gaming rules.

20. The system of claim 19, wherein the game comprises Babels city.
